(19) United States
(12) Patent Application Publication
(10) Pub. No.: US 2014/0157846 A1
(43) Pub. Date: Jun. 12, 2014

(54) METHODS AND SYSTEMS FOR TREATING BIOREACTOR WASTEWATER STREAMS

(71) Applicant: ThermoEnergy Corporation, Worcester, MA (US)

(72) Inventors: Sam S. Jeppson, Worcester, MA (US); Mark M. Simon, Wilbraham, MA (US); Thomas Karl Bisson, Plymouth, MA (US)

(73) Assignee: ThermoEnergy Corporation, Worcester, MA (US)

(21) Appl. No.: 13/711,745

(22) Filed: Dec. 12, 2012

(51) Int. Cl. C02F 1/04; C05C 11/00; C05C 3/00; C01C 1/28

(52) U.S. Cl. CPC C02F 1/048; C01C 1/28; C05C 11/00; C05C 3/00
USPC 71/54; 423/352; 71/61; 203/12

(57) ABSTRACT

Methods and systems for treating bioreactor wastewater streams are provided. In some embodiments, the methods and systems involve producing a composition, for example in the form of a solution, comprising ammonia or ammonium from the bioreactor wastewater stream. In some cases, the bioreactor is an anaerobic digester.

### FIELD

Methods and systems for treating bioreactor wastewater streams are provided. In some embodiments, the methods and systems involve producing a composition, for example in the form of a solution, comprising ammonia or ammonium from the bioreactor wastewater stream. In some cases, the bioreactor is an anaerobic digester.

### BACKGROUND

There is a growing need for systems and methods for treating water streams which reduce toxic or harmful discharges and/or aid in the recovery of target chemicals. Such recovery systems can allow for reuse of the water by removal of contaminants or reaction products and recovery of certain such materials as desired target chemicals. For example, anaerobic digester wastewater effluent discharge poses an ever increasing contamination threat to associated receiving bodies of water. Municipal wastewater treatment plants throughout the United States are currently faced with the difficult challenge of complying with increasingly stringent discharge limitations.

One target chemical of interest for recovery from wastewater (e.g., bioreactor wastewater) is ammonium/ammonia. If discharged into receiving bodies of water, ammonium/ammonia is toxic to fish and other aquatic life, even at very low concentration levels. In addition, nitrification of ammonium/ammonia to nitrite and nitrate can occur naturally under the typical aerobic conditions of the receiving bodies of water. This nitrification process can create an oxygen deficiency that causes stress and possible death to the fish population.

Methods and/or systems that would remove and/or recover ammonium/ammonia from anaerobic digester (AD) wastewater streams could significantly reduce the total nitrogen discharge of the wastewater treatment plant. Accordingly, such improved methods and systems are needed.

### SUMMARY

In some embodiments, method for producing a composition comprising ammonia and/or ammonium from a bioreactor wastewater stream are provided. In some embodiments, the method comprises providing an acid-treated wastewater steam from a bioreactor, wherein the acid-treated bioreactor wastewater stream comprises ammonia and/or ammonium at a first concentration, to an evaporation system wherein a portion of the acid-treated bioreactor wastewater stream is vaporized and a bottoms liquid is formed comprising a de-watered, more concentrated solution of the ammonia and/or ammonium, the bottoms liquid having a second concentration of ammonia and/or ammonium which is greater than the first concentration; and collecting the bottoms liquid.

### BRIEF DESCRIPTION OF THE DRAWINGS

FIG. 1 shows a flow diagram of a non-limiting method for treating anaerobic digester (AD) wastewater streams, according to one set of embodiments;

FIG. 2 shows an exemplary system including a CAST® system, which can be used to form a concentrated ammonium-containing solution according to one set of embodiments; and

FIG. 3 is a flow diagram showing pre-treatment systems that can be used in the context of a method of the invention for treating AD wastewater streams, as well as the treatment steps, according to one set of embodiments.

Other aspects, embodiments, and features of the invention will become apparent from the following detailed description when considered in conjunction with the accompanying drawings. The accompanying figures are schematic and are not intended to be drawn to scale. For purposes of clarity, not every component is labeled in every figure, nor is every component of each embodiment of the invention shown where illustration is not necessary to allow those of ordinary skill in the art to understand the invention. All patent applications and patents incorporated herein by reference are incorporated by reference in their entirety. In case of conflict, the present specification, including definitions, will control.

### DETAILED DESCRIPTION

The present description generally relates to methods and systems for treating bioreactor wastewater streams. In some embodiments, the bioreactor wastewater stream contains ammonia/ammonium. The methods and systems described herein comprise concentrating the ammonia/ammonium in the bioreactor wastewater stream. In some embodiments, the bioreactor wastewater stream is acid-treated. In some embodiments, the bioreactor is an anaerobic digester (AD). In certain embodiment, the treated bioreactor wastewater stream may be collected and used, e.g. as a fertilizer product.

It should be understood, that while much of the discussion herein focuses embodiments wherein the bioreactor wastewater stream is an AD wastewater stream, this is by no means limiting, and wastewater streams obtained from other types of bioreactors may be employed.

In some embodiments, a method for concentrating ammonia/ammonium from an acid-treated AD wastewater stream proceeds as follows. An acid-treated AD wastewater stream comprising ammonia and/or ammonium is provided. The temperature and pH of the water may be adjusted, which results in the shifting of the ammonium/ammonia equilibrium towards the formation of ammonium (e.g., as an ammonium salt) or converting a substantial portion of the ammonia or dissolved ammonia gas into ammonium. The water containing the converted ammonium is introduced into an evaporation system, which is used to form a vapor portion comprising water and a bottoms portion, wherein the bottoms portion has a higher concentration of ammonium and/or ammonia as compared to the acid-treated AD wastewater stream initially introduced into the evaporation system due to the removal of water in the vapor portion. The bottoms portion may be collected and further processed.

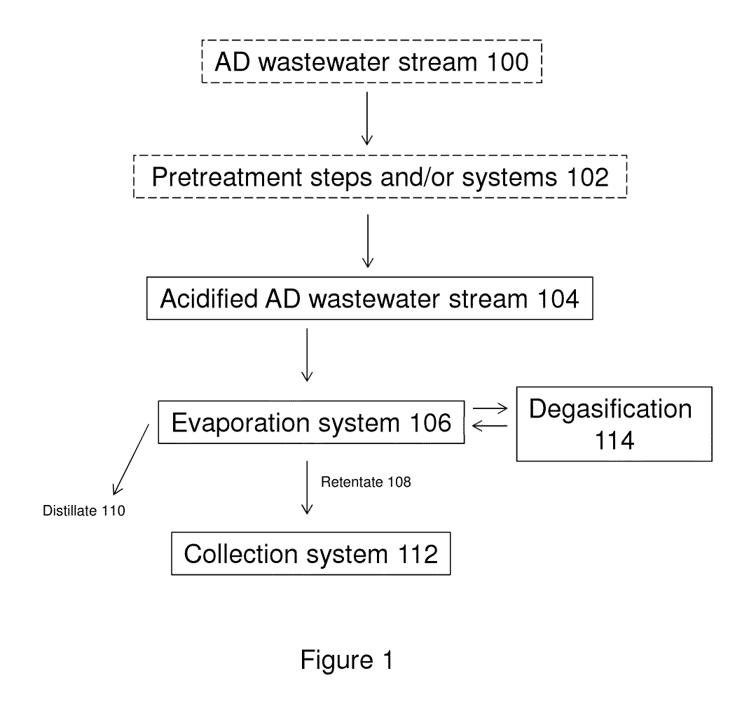

FIG. 1 shows a flow diagram of an exemplary method for producing a solution comprising ammonia and/or ammonium from an acid-treated AD wastewater stream. In FIG. 1, acid-treated AD wastewater steam 104 is introduced into evaporation system 106, wherein the acid-treated AD wastewater stream comprises ammonia and/or ammonium at a first concentration. The acid-treated AD wastewater steam 104 in certain cases is produced from an AD wastewater stream 100 via one or more pre-treatment steps (e.g., acidification, reverse osmosis, filtration, etc.; FIG. 1, 102) as described below. For example, acid-treated AD wastewater stream 104 may have been formed by adding an acid to an AD wastewater stream 100. In evaporation system 106, a portion of the acid-treated AD wastewater stream is vaporized. Bottoms portion 108 remains after partial vaporization and comprises a de-watered solution of the ammonia and/or ammonium, wherein retentate 108 has a second concentration of ammonia and/or ammonium which is greater than the first concentration in stream 104. Bottoms portion 108 may be collected, for example via collection system 112. Vapor portion (distillate 110) (e.g., comprising water vapor) may be condensed, collected, disposed of, and/or reused in the anaerobic digester. Each of the above steps and related systems and techniques are described in more detail below.

In some embodiments, following introduction of the acid-treated AD wastewater to the evaporation system, the method further comprises degasifying the acid-treated AD wastewater stream (e.g., FIG. 1, 114). The degasification may occur prior to and/or intermittently during the vaporization process. For example, in some embodiments, the acid-treated AD wastewater stream is degasified following introduction of the wastewater to the evaporation system but prior to subjecting the wastewater to the vaporization. Alternatively or in addition, in some embodiments, the acid-treated AD wastewater is degasified intermittently during vaporization. For example, during the vaporization process, the solution may be degasified or the vaporization process may be temporarily stopped and the wastewater may be degasified during such interval.

In some embodiments, degasification is carried out so as to prevent or reduce foaming of the acid-treated AD wastewater stream. Without wishing to be bound by theory, in some embodiments, preventing or reducing foaming of the acid-treated AD wastewater can facilitate or improve retention of the ammonia/ammonium in the bottoms portion by preventing loss of ammonia/ammonium in the vapor portion, e.g. by aerosolization. For example, in some embodiments, without a degasifying step, during the vaporization step in the evaporation system, the bottoms portion in the evaporation system will foam substantially. The foaming may result in some portion of the bottoms spilling over into or being entrained in the vapor portion. Thus loss of ammonia/ammonium in the bottoms and concomitant contamination of the vapor portion with ammonia/ammonium may be observed due to the loss of some portion of the bottoms into the vapor portion exiting the evaporation system 106.

In some embodiments, the degasification aids in removal of a gas formed during the conversion of ammonia to ammonium. For example, in some embodiments, the degasification aids in the removal of any additional gas formed during the conversion of ammonia or ammonium. In some cases, the additional gas is formed upon addition of an additive to the system, wherein the additive reacts with ammonia to form ammonium and a gas. In some cases, degasification is carried out following addition of an additive to the acid-treated AD wastewater stream 104. For example, as described herein, in some embodiments, following addition of the acid-treated AD wastewater stream to the evaporation system or during the vaporization, additional acid is added to the acid-treated AD wastewater stream so as to adjust the pH of the acid-treated AD wastewater stream in the evaporation system. Such further addition of acid may cause any ammonia present in the acid-treated AD wastewater stream to be converted to ammonium (e.g., an ammonium salt). The conversion, however, may result in the release of additional gas (e.g., carbon dioxide). As a non-limiting example, in embodiments wherein the acidified AD wastewater stream is further treated with citric acid, carbon dioxide is produced via the conversion of ammonia to ammonium.

A variety of known methods and systems for degasifying the acid-treated AD wastewater stream (e.g., once provided to an evaporation system) can potentially be used in the context of the present invention. In some embodiments, degasification comprises one or more of agitating, heating, or applying a vacuum to the acid-treated AD wastewater stream in the evaporation system. In some embodiments, the degasification may comprise addition of a defoamer to the wastewater. Defoamers are commercially available (e.g., surfactants, alcohol-based defoamers, oils, etc.). In some embodiments, degasification involves agitating the solution, for example, by stirring, shaking, etc. In some embodiments, degasification involves applying a vacuum to the acid-treated AD wastewater stream (e.g., by forming a vacuum in the evaporation system). In some embodiments, the pressure maintained in the evaporation system during the vaporization step and/or during degasifying is between about 10 and about 29 inches Hg vacuum, or between about 15 and about 29 inches Hg vacuum, or between 20 and about 29 inches Hg vacuum, or between about 25 and about 29 inches Hg vacuum, or between about 26 and about 29 inches Hg vacuum, or between about 27 and about 29 inches Hg vacuum, or between about 28 and about 29 inches Hg vacuum, or about 25 inches Hg vacuum, or about 26 inches Hg vacuum, or about 27 inches Hg vacuum, or about 28 inches Hg vacuum, or about 29 inches Hg vacuum. In some embodiments, the degasification involves heating the solution. In some embodiments, the temperature of the evaporation system during the vaporization step and/or during degasifying is between about 100 F and about 160 F, or between about 110 F and about 160 F, or between about 120 F and about 160 F, or between about 130 F and about 160 F, or between about 140 F and about 160 F, or between about 150 F and about 160 F, or between about 100 F and about 150 F, or between about 100 F and about 140 F, or between about 100 F and about 130 F, or between about 100 F and about 120 F, or between about 100 F and about 110 F, or between about 110 F and about 150 F, or between about 110 F and about 140 F, or between about 110 F and about 130 F, or between about 110 F and about 120 F, or between about 120 F and about 150 F, or between about 120 F and about 140 F, or between about 120 F and about 130 F, or between about 130 F and about 140 F. In one embodiment, the temperature is between about 110 F and about 130 F. In certain embodiments, the degasification process combines at least two, several, or all of the degasification techniques discussed above.

In some embodiments, the acid-treated AD wastewater stream contains one or more organic compounds. As will be understood by those of ordinary skill in the art, AD wastewater streams generally contain a wide variety of organic compounds. In some embodiments, the organic compounds comprise common byproducts from the AD process. These organic compounds may create, worsen, or influence foaming of the acid-treated AD wastewater stream during the vaporization process. That is, the organic compounds can contribute to the presence of foaming during the vaporization process as compared to a wastewater stream which does not contain such organic compounds. In some cases, at least one such organic compound is a surfactant. Other non-limiting examples of types of organic compounds which may be found in AD wastewater streams include fatty acids, proteins, lipids, polysaccharides, and polynucleotides.

In some embodiments, following addition of the acid-treated AD wastewater stream to the evaporation system and prior to or during vaporization, the conditions of the acid-treated AD wastewater stream may be modified (e.g., via further acidification) so as to facilitate conversion of ammonia to ammonium. In some embodiments, the conditions of the acid-treated AD wastewater stream may be adjusted so all of or substantially all of the ammonia is in the form of ammonium (e.g., an ammonium salt). Having all or substantially all of the ammonia in the form of ammonium may reduce loss of total ammonia/ammonium from the bottoms portion, in part, by preventing any loss of ammonia gas in the vapor portion produced during the vaporization step.

A variety of methods and conditions for shifting the ammonia/ammonium equilibrium can be employed for the above-discussed purpose. Generally, as the temperature or pH is decreased (e.g., via addition of an acid), the equilibrium shifts towards the presence of ammonium. For example, the wastewater may be optionally cooled, one or more pH reducing additives can be provided to the wastewater stream, or the vacuum pressure of the wastewater stream may be decreased to facilitate or aid in conversion/further conversion of ammonia to ammonium. In some embodiments, reduction of pH via addition of an acid or adjustment of other conditions of the wastewater (e.g., pressure, temperature) shifts the ammonium/ammonia equilibrium such that a substantial portion or substantially all of the ammonia is present in the acid-treated AD wastewater as ammonium.

In some embodiments, the AD wastewater stream is pre-treated prior to introduction into the evaporization system. For example, an AD wastewater stream can be acid-treated to form the acid-treated AD wastewater stream introduced into the evaporation system. Accordingly, as used herein, an acid-treated AD wastewater stream is an AD wastewater stream which has been pre-treated prior to introduction into an evaporation system via addition of an acid. It should be understood that this does not necessarily mean that the acid-treated AD wastewater stream necessarily has an acidic pH. In some embodiments, the acid-treated AD wastewater stream may have a basic or neutral pH. In some embodiments, the pH of the acid-treated AD wastewater stream prior to providing such acid-treated AD wastewater to the evaporation system is between about 1 and about 8, or between about 2 and about 8, or between about 3 and about 8, or 4 and about 8, or between about 5 and about 7, or between about 6 and about 7, or about 1, or about 2, or about 3, or about 4, or about 4.5, or about 5, or about 5.5, or about 6, or about 6.5, or about 7, or about 7.5, or about 8.

In some embodiments, the pH and other parameters (e.g., temperature, pressure) are adjusted via experimentation and optimization so that substantially all of the ammonia/ammonium is in the form of ammonium. Selecting the parameters so that substantially all of the ammonia is in the form of ammonium can be desirable to facilitate recovery of the ammonium in the bottoms portion of the evaporation system and minimize losses via ammonia gas being contained in the vapor portion of the evaporation system. In some embodiments, the pH of the acid-treated AD wastewater stream during the vaporization may be between about 1 and about 8, or between about 2 and about 8, or between about 3 and about 8, or 4 and about 8, or between about 5 and about 7, or between about 6 and about 7, or about 1, or about 2, or about 3, or about 4, or about 4.5, or about 5, or about 5.5, or about 6, or about 6.5, or about 7, or about 7.5, or about 8.

In some embodiments, additional acid may be added to the acid-treated AD wastewater stream during the evaporation process. This may occur during the evaporation process or intermittently during periods when the vaporization process is halted for a period of time, e.g. while the acid is being added. Additional acid may be added to adjust the pH of the acid-treated AD wastewater during the evaporation process so as to affect the ammonia/ammonium equilibrium favorably for more complete recovery in the bottoms portion. Concentrating the acid-treated AD wastewater and/or removal of a gas from the wastewater (e.g., carbon dioxide) may cause the pH of the acid-treated AD wastewater stream to increase or decrease. The acid added during the evaporation may or may not be the same acid employed during pre-treatment of the AD wastewater stream to form the acid-treated AD wastewater stream. In some embodiments, the acid employed is an organic acid, while in other embodiments an inorganic acid or a combination of an organic acid and an inorganic acid is used. Non-limiting examples of acids useful or potentially useful for such purpose include sulfuric acid, phosphoric acid, citric acid, nitric acid, hydrochloric acid, or acetic acid. In one embodiment, the acid is or includes citric acid.

In some embodiments, the pH of the acid-treated wastewater stream (e.g., prior to or following addition the evaporation system) may depend on the type of acid which was used to acidify the solution. For example, the minimum pH of solutions, in some embodiments, comprising exemplary acids are given below in Table 1. It should be understood that the pH of a wastewater stream comprising these acids is not necessarily the pH given in the table, however, the pH may be the lowest desirable pH of an acid-treated AD wastewater stream comprising each acid. Lower pH levels may be achievable depending on the acid employed.

TABLE 1

| | pH of Acid |
|---|---|
| Acid/Ammonium Salt | Solution |
| Sulfuric/Ammonium Sulfate | 2 |
| Nitric/Ammonium Nitrate | 2 |
| Acetic/Ammonium Acetate | 3-4 |
| Phosphoric/Ammonium Phosphate | 2-3 |
| Chloric/Ammonium Chloride | 2 |
| Citric/Ammonium Citrate | 4 |

In certain embodiments, it may be advantageous to adjust the pH of the acid-treated wastewater stream to a value higher than the exemplary minimum pH levels provided in Table 1. In some embodiments, wherein the acid is sulfuric acid, nitric acid, phosphoric acid, or hydrochloric acid, the pH of the acid-treated AD wastewater stream is not less than 2, or between about 2 and 8, or between about 3 and 8, or between about 4 and 8, or between about 5 and 8, or between about 6 and 8, or about 2, or about 3, or about 4, or about 4.5, or about 5, or about 5.5, or about 6, or about 6.5, or about 7, or about 7.5, or about 8. In some embodiments, wherein when acid is acetic acid or phosphoric acid, the pH of the acid-treated AD wastewater stream is not less than 3, or between about 3 and 8, or between about 4 and 8, or between about 5 and 8, or between about 6 and 8, or about 3, or about 4, or about 4.5, or about 5, or about 5.5, or about 6, or about 6.5, or about 7, or about 7.5, or about 8. In some embodiments, wherein the acid is acetic acid or citric acid, the pH of the acid-treated AD wastewater stream is not less than 4, or between about 4 and 8, or between about 5 and 8, or between about 6 and 8, or about 4, or about 4.5, or about 5, or about 5.5, or about 6, or about 6.5, or about 7, or about 7.5, or about 8.

In some embodiments, the evaporation system is configured and operated so that the bottoms portion from the evaporation system has a second concentration of ammonia and/or ammonium which is greater than the concentration of ammonia and/or ammonium in the acid-treated AD wastewater stream initially provided to the evaporation system for treatment. In some embodiments, the second concentration is 1.5 times, or 2 times, or 3 times, or 4 times, or 5 times, or 6 times, or 7 times, or 8 times, or 9 times, or 10 times, or 15 times, or 20 times, or 30 times, or 40 times, 50 times, or 60 times, or 70 times, or 80 times, or 90 times, or 100 times, or more greater than the first concentration. In some embodiments, the second concentration of ammonia and/or ammonium is about or greater than about 5 wt %, or about or greater than about 6 wt %, or about or greater than about 7 wt %, or about or greater than about 8 wt %, or about or greater than about 9 wt %, or about or greater than about 10 wt %, or about or greater than about 15 wt %, or about or greater than about 20%, or about or greater than about 25%, or about or greater than about 30%, or about or greater than about 35%, or about or greater than about 40%, or about or greater than about 45%, or about or greater than about 50%, or about or greater than about 55%, or about or greater than about 60%, or about or greater than about 65%. In some embodiments, the second concentration of ammonia and/or ammonium is between about 5 wt % and about 15 wt %, or between about 5 wt %, and about 10 wt %, or between about 10 wt % and about 60 wt %, or between about 10 wt % and about 50 wt %, or between about 10 wt % and about 40 wt %, or between about 10 wt % and about 30 wt %, or between about 10 wt % and about 20 wt %, or between about 5 wt % and about 20 wt %, or between about 5 wt % and about 30 wt %. In some embodiments, the second concentration is less than the concentration at which the ammonium acid salt would precipitate in the solution in which it is contained (e.g., the maximum soluble concentration of the ammonium acid salt). In some embodiments, the second concentration of ammonia and/or ammonium is between about 0.1 wt % and about 5 wt %, or between about 0.1 wt % and about 10 wt %, or between about 0.1 wt %, and about 15 wt %, or between about 0.1 wt % and about 20 wt %, or between about 0.1 wt % and about 30 wt %, or between about 0.1 wt % and about 30 wt %, or between about 0.1 wt % and about 40 wt %, or between about 0.1 wt % and about 50 wt %. In some embodiments, the second concentration of ammonia and/or ammonium is between about between about 0.5 wt % and about 5 wt %, or between about 0.5 wt % and about 10 wt %, or between about 0.5 wt %, and about 15 wt %, or between about 0.5 wt % and about 20 wt %, or between about 0.5 wt % and about 30 wt %, or between about 0.5 wt % and about 30 wt %, or between about 0.5 wt % and about 40 wt %, or between about 0.5 wt % and about 50 wt %. Those of ordinary skill in the art will be aware of the concentration at which various ammonium acid salt precipitate in a solution. Non-limiting examples of solubility limits for exemplary ammonium acids salts in an aqueous solution are provided in Table 2.

TABLE 2

| Acid/Ammonium Acid Salt | Maximum Solubility of Salt % |
|---|---|
| Sulfuric/Ammonium Sulfate | 43% |
| Nitric/Ammonium Nitrate | 66% |
| Acetic/Ammonium Acetate | 59% |
| Phosphoric/Ammonium Phosphate | 17% |
| Chloric/Ammonium Chloride | 27% |
| Citric/Ammonium Citrate | 22%-40% (e.g., depending on |
| | the disassociation of ions) |

In some embodiments, wherein the acid is sulfuric acid, the second concentration of ammonia and/or ammonium is not more than about 43 wt %, or between about 5 wt % and about 43 wt %, or between about 5 wt % and about 40 wt %, or between about 5 wt % and about 30 wt %, or between about 5 wt % and about 20 wt %, or between about 5 wt %, and about 15 wt %, or between about 5 wt % and about 10 wt %. In some embodiments, wherein the acid is sulfuric acid, the second concentration of ammonia and/or ammonium is between about 0.5 wt % and about 43 wt %, or between about 0.5 wt % and about 40 wt %, or between about 0.5 wt % and about 30 wt %, or between about 0.5 wt % and about 20 wt %, or between about 0.5 wt %, and about 15 wt %, or between about 0.5 wt % and about 10 wt %, or between about 0.5 wt % and about 5 wt %. In some embodiments, wherein the acid is sulfuric acid, the second concentration of ammonia and/or ammonium is between about 0.1 wt % and about 43 wt %, or between about 0.1 wt % and about 40 wt %, or between about 0.1 wt % and about 30 wt %, or between about 0.1 wt % and about 20 wt %, or between about 0.1 wt %, and about 15 wt %, or between about 0.1 wt % and about 10 wt %, or between about 0.1 wt % and about 5 wt %.

In some embodiments, wherein the acid is nitric acid, the second concentration of ammonia and/or ammonium is not more than about 66%, or between about 5 wt % and about 66 wt %, or between about 5 wt % and about 60 wt %, or between about 5 wt % and about 50 wt %, or between about 5 wt % and about 40 wt %, or between about 5 wt % and about 30 wt %, or between about 5 wt % and about 20 wt %, or between about 5 wt %, and about 15 wt %, or between about 5 wt % and about 10 wt %. In some embodiments, wherein the acid is nitric acid, the second concentration of ammonia and/or ammonium is between about 0.5 wt % and about 66 wt %, or between about 0.5 wt % and about 60 wt %, or between about 0.5 wt % and about 50 wt %, or between about 0.5 wt % and about 40 wt %, or between about 0.5 wt % and about 30 wt %, or between about 0.5 wt % and about 20 wt %, or between about 0.5 wt %, and about 15 wt %, or between about 0.5 wt % and about 10 wt %, or between about 0.5 wt % and about 5 wt %. In some embodiments, wherein the acid is nitric acid, the second concentration of ammonia and/or ammonium is between about 0.1 wt % and about 66 wt %, or between about 0.1 wt % and about 60 wt %, or between about 0.1 wt % and about 50 wt %, or between about 0.1 wt % and about 40 wt %, or between about 0.1 wt % and about 30 wt %, or between about 0.1 wt % and about 20 wt %, or between about 0.1 wt %, and about 15 wt %, or between about 0.1 wt % and about 10 wt %, or between about 0.1 wt % and about 5 wt %.

In some embodiments, wherein the acid is acetic acid, the second concentration of ammonia and/or ammonium is not more than about 59 wt %, or between about 5 wt % and about 59 wt %, or between about 5 wt % and about 50 wt %, or between about 5 wt % and about 40 wt %, or between about 5 wt % and about 30 wt %, or between about 5 wt % and about 20 wt %, or between about 5 wt %, and about 15 wt %, or between about 5 wt % and about 10 wt %. In some embodiments, wherein the acid is acetic acid, the second concentration of ammonia and/or ammonium is between about 0.5 wt % and about 59 wt %, or between about 0.5 wt % and about 50 wt %, or between about 0.5 wt % and about 40 wt %, or between about 0.5 wt % and about 30 wt %, or between about 0.5 wt % and about 20 wt %, or between about 0.5 wt %, and about 15 wt %, or between about 0.5 wt % and about 10 wt %, or between about 0.5 wt % and about 5 wt %. In some embodiments, wherein the acid is acetic acid, the second concentration of ammonia and/or ammonium is between about 0.1 wt % and about 59 wt %, or between about 0.1 wt % and about 50 wt %, or between about 0.1 wt % and about 40 wt %, or between about 0.1 wt % and about 30 wt %, or between about 0.1 wt % and about 20 wt %, or between about 0.1 wt %, and about 15 wt %, or between about 0.1 wt % and about 10 wt %, or between about 0.1 wt % and about 5 wt %.

In some embodiments, wherein the acid is phosphoric acid, the second concentration of ammonia and/or ammonium is not more than about 17 wt %, or between about 5 wt % and about 17 wt %, or between about 5 wt %, and about 15 wt %, or between about 5 wt % and about 10 wt %. In some embodiments, wherein the acid is phosphoric acid, the second concentration of ammonia and/or ammonium is between about 0.5 wt % and about 17 wt %, or between about 0.5 wt %, and about 15 wt %, or between about 0.5 wt % and about 10 wt %, or between about 0.5 wt % and about 5 wt %. In some embodiments, wherein the acid is phosphoric acid, the second concentration of ammonia and/or ammonium is between about 0.1 wt % and about 17 wt %, or between about 0.1 wt %, and about 15 wt %, or between about 0.1 wt % and about 10 wt %, or between about 0.1 wt % and about 5 wt %.

In some embodiments, wherein the acid is hydrochloric acid, the second concentration of ammonia and/or ammonium is not more than about 27 wt %, or between about 5 wt % and about 27 wt %, or between about 5 wt % and about 20 wt %, or between about 5 wt %, and about 15 wt %, or between about 5 wt % and about 10 wt %. In some embodiments, wherein the acid is hydrochloric acid, the second concentration of ammonia and/or ammonium is between about 0.5 wt % and about 27 wt %, or between about 0.5 wt % and about 20 wt %, or between about 0.5 wt %, and about 15 wt %, or between about 0.5 wt % and about 10 wt %, or between about 0.5 wt % and about 5 wt %. In some embodiments, wherein the acid is hydrochloric acid, the second concentration of ammonia and/or ammonium is between about 0.1 wt % and about 27 wt %, or between about 0.1 wt % and about 20 wt %, or between about 0.1 wt %, and about 15 wt %, or between about 0.1 wt % and about 10 wt %, or between about 0.1 wt % and about 5 wt %.

In some embodiments, wherein the acid is citric acid, the second concentration of ammonia and/or ammonium is not more than about 40 wt %, or between about 5 wt % and about 22 wt %, or between about 5 wt % and about 40 wt %, or between about 5 wt % and about 30 wt %, or between about 5 wt % and about 20 wt %, or between about 5 wt %, and about 15 wt %, or between about 5 wt % and about 10 wt %. In some embodiments, wherein the acid is citric acid, the second concentration of ammonia and/or ammonium is between about 0.5 wt % and about 22 wt %, or between about 0.5 wt % and about 40 wt %, or between about 0.5 wt % and about 30 wt %, or between about 0.5 wt % and about 20 wt %, or between about 0.5 wt %, and about 15 wt %, or between about 0.5 wt % and about 10 wt %. In some embodiments, wherein the acid is citric acid, the second concentration of ammonia and/or ammonium is between about 0.1 wt % and about 22 wt %, or between about 0.1 wt % and about 40 wt %, or between about 0.1 wt % and about 30 wt %, or between about 0.1 wt % and about 20 wt %, or between about 0.1 wt %, and about 15 wt %, or between about 0.1 wt % and about 10 wt %.

In some embodiments, a system or method of the present invention may comprise or make use of an evaporation system. An evaporation system is generally adapted and arranged to separate a water stream into a vapor portion and a bottoms portion. Suitable unit operations and design parameters and operating conditions for configuring evaporation systems to perform a desired reaction/separation according to the disclosure will be discernible to those of ordinary skill in the art, given the knowledge of those skilled in the art supplemented and informed by the description provided herein. In some embodiments, an evaporation system comprises a component (e.g., a vaporizer) which allows for at least a portion of a water stream to be vaporized, thereby forming a vapor portion and a non-vapor portion, e.g., the bottoms liquid or retentate. In preferred embodiments, the evaporation system is a vacuum assisted flash evaporation system (e.g., a CAST® system, commercially available from ThermoEnergy, Inc., Worcester, Mass.).

As described above, in some embodiments, the conditions for operation of the evaporation system are adjusted following addition of the acid-treated wastewater stream to the system so as to convert or further convert of any ammonia in the acid-treated wastewater stream into ammonium. Such adjustments may prevent any loss of ammonia/ammonium in the vapor stream leaving the system, as previously discussed. For example, if the ammonia/ammonium is present as ammonia gas, the ammonia gas may be undesirably lost in the vapor portion leaving the evaporation system.

A variety of suitable evaporation systems may be used in connection with the methods described herein. In some preferred embodiments, the evaporation system comprises a CAST® vaporizer/evaporation system. A CAST® system is a proprietary flash distillation unit operation which is commercially available from ThermoEnergy, Inc., Worcester, Mass. The CAST® system is adapted for separating a water stream into a vapor portion and a liquid, bottoms portion, and collecting the bottoms portion which contains a target chemical and/or a chemically modified form thereof (e.g., ammonium/ammonia). CAST® systems are described in more detail in U.S. Pat. No. 4,770,748, issued Sep. 13, 1988, entitled “Vacuum Distillation System” and having the inventors Cellini et al.; U.S. Pat. No. 4,880,504, issued Nov. 14, 1989, entitled “Vacuum Distillation System with Spiralled Cold Coil” and having the inventors Cellini et al.; U.S. Pat. No. 7,270,796, issued Sep. 18, 2007, entitled “Ammonium/Ammonia Removal form a Stream” and having the inventors Kemp et al.; and U.S. Patent Publication No. 2007/0297953 A1, published Dec. 27, 2007, entitled “Ammonium/Ammonia Removal form a Stream” and having the inventors Kemp et al., each of which is owned by the assignee of the present application and incorporated herein by reference in its entirety for all purposes.

In some embodiments, the evaporation system comprising a mechanical vapor recompression (MVR) system. In some cases, the evaporation system comprises a Turbo CAST® vaporizer/evaporation system. A Turbo CAST® system is a proprietary flash distillation unit operation (e.g., Turbo CAST®, commercially available from ThermoEnergy, Inc., Worcester, Mass.). A Turbo CAST® system employs a mechanical vapor recompression MVR high temperature system which has a relatively high heat recovery/efficiency. The Turbo CAST® system may be used as evaporation system for removing a target chemical such as ammonia/ammonium from a water stream as described herein. In some embodiments, the Turbo CAST® system is used in place of a CAST® system in embodiments described herein. A Turbo CAST® system may be used in applications involving, for example, high flows, low concentrations of target chemical in the water stream, or in locations that have high energy costs.

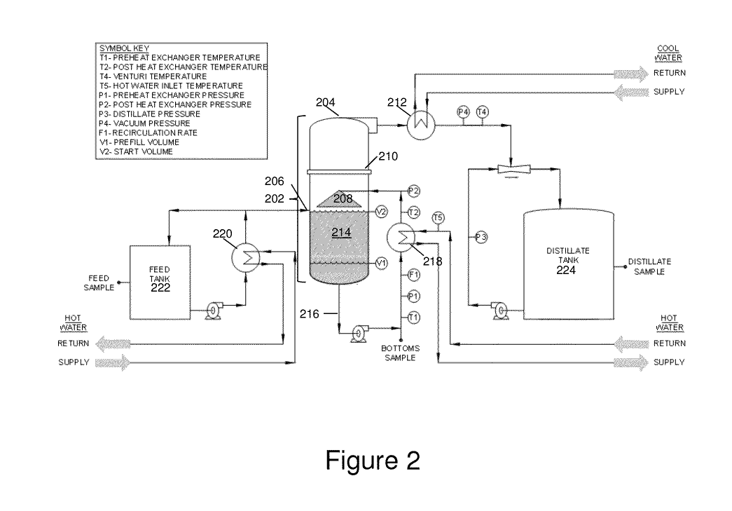

FIG. 2 depicts a non-limiting example of evaporation system 202 (e.g., CAST® or Turbo CAST® system) and related components. The acid-treated AD wastewater stream (e.g., comprising water and ammonia/ammonium) is provided to vessel 204, via inlet 206 or spray nozzle 208. The portion of the wastewater provided via spray nozzle 208 may be selected in such a manner that the wastewater is partially vaporized thereby forming a vapor portion comprising water vapor. The vapor portion rises and passes through a baffle 210 to condenser 212, where the vapor is condensed to form an effluent comprising water. Baffle 210 aids in minimizing dissolved salt carry over. The portion of wastewater that is not vaporized (e.g., bottoms 214) collects in the bottom of vessel 204 and contains most or substantially all of the ammonium. The bottoms may optionally be continually cycled through the spray nozzle (e.g., via fluid conduit 216) for any suitable period of time to remove the desired amount of water vapor. At the end of the evaporation process, the bottoms comprises an ammonium/ammonia concentration which is greater than the concentration of ammonium/ammonia in the acid-treated AD wastewater stream initially provided to the evaporation system.

The treatment system may optionally comprise other components or unit operations. For example, the system may comprise one or more heat exchanges (e.g., 218, 220) to heat the acid-treated AD wastewater stream prior to introduction to vessel 204. Other components may include feed tank 222 (e.g., comprising the acid-treated AD wastewater stream), distillate tank 224 (e.g., for collecting the condensed vapor portion condensed by condenser 212), fluid conduits, vacuum pumps, venturis, monitor probes and/or outlets (e.g., for monitoring the pressure, temperature, pH, etc., of the wastewater stream at one or more locations), heaters, and condensers.

In some embodiments, the vapor portion comprising water is produced in an evaporation system (e.g., a CAST® system) by spraying the water stream into a container (e.g., a CAST® container) using a spray nozzle. As the water is sprayed from the spray nozzle, a vapor portion forms which comprises water vapor. The water vapor portion may be drawn (e.g., via vacuum) through a baffle situated in the upper portion of the container. The liquid portion of the sprayed water comprising the ammonium is collected in the bottom of the container and can be further processed and/or collected as described herein.

Baffles and other components suitable for use in an evaporation system (e.g., CAST® system) have been described previously. See, for example, U.S. Pat. Nos. 4,770,748 and 4,880,504. The water vapor may be drawn through the baffle for collection using any suitable known methods and systems. In some embodiments, the water vapor is drawn through the baffle using a venturi or vacuum pump that creates a vacuum on the container. The vacuum may be provided at a pressure such that substantially all or a substantial portion of the water vapor is withdrawn from the container.

In some embodiments, an evaporation system may make use of one or more condensers 212, for example, to condense and collect the water vapor. Suitable condenser systems and methods are well known commercially available.

The evaporation system may be adapted to treat, for example, at least 500 gallons the acid-treated AD wastewater stream per day (GPD), at least 1,000 GPD, at least 3,000 GPD, at least 5,000 GPD, at least 10,000 GPD, at least 20,000 GPD, at least 50,000 GPD, at least 100,000 GPD, at least 500,000 GPD, or at least 1,000,000 GPD. In some embodiments, larger treatment rates or capacities can be facilitated without unduly large vessels and unit operation capacities by, for example, providing several smaller capacity systems described herein arranged in parallel.

The evaporation system may be operated at any suitable temperature. In some embodiments, the evaporation system is operated at a temperature of at least about 100 F, at least about 110 F, at least about 120 F, at least about 130 F, at least about 140 F, at least about 150 F, at least about 160 F, or greater. In some cases, the system is operated at a temperature between about 100 F and about 160 F, or between about 110 F and about 160 F, or between about 120 F and about 160 F, or between about 130 F and about 160 F, or between about 140 F and about 160 F, or between about 150 F and about 160 F, or between about 100 F and about 150 F, or between about 100 F and about 140 F, or between about 100 F and about 130 F, or between about 100 F and about 120 F, or between about 100 F and about 110 F, or between about 110 F and about 150 F, or between about 110 F and about 140 F, or between about 110 F and about 130 F, or between about 110 F and about 120 F, or between about 120 F and about 150 F, or between about 120 F and about 140 F, or between about 120 F and about 130 F, or between about 130 F and about 140 F. In one embodiment, the temperature is between about 110 F and about 130 F. The evaporation system may be operated at any suitable pressure. In some embodiments, the evaporation system is operated at a pressure between about 10 and about 29 inches Hg vacuum, or between about 15 and about 29 inches Hg vacuum, or between 20 and about 29 inches Hg vacuum, or between about 25 and about 29 inches Hg vacuum, or between about 26 and about 29 inches Hg vacuum, or between about 27 and about 29 inches Hg vacuum, or between about 28 and about 29 inches Hg vacuum, or about 25 inches Hg vacuum, or about 26 inches Hg vacuum, or about 27 inches Hg vacuum, or about 28 inches Hg vacuum, or about 29 inches Hg vacuum.

### Pre-Processing Systems and Methods

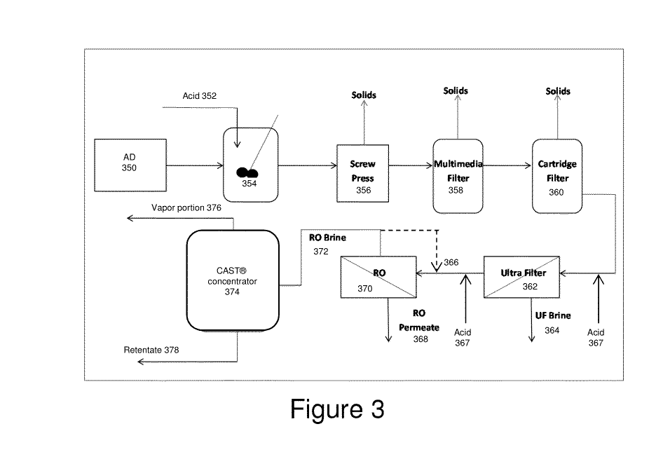

The inventive methods and systems described herein may be used in combination with any other number of system components and method steps to prepare or pre-process the AD wastewater prior to introduction of acid-treated AD wastewater into an evaporation system (e.g., CAST® concentrator) as described herein. For example, such pre-treatments may be selected and performed in order to improve or optimize overall performance or improve the efficiency or power consumption of the inventive methods and systems. Examples of additional treatments and components that may be advantageously employed in certain embodiments include dissolved air flotation, multimedia filtration, ultraviolet irradiation, ion exchange softening, ultrafiltration or reverse osmosis, or chemical treatment systems (e.g., for chlorination, ozonation, peroxidation and the like) or combinations of these treatments/components. Additional description of potentially useful pre-processing systems and methods can be found in commonly owned U.S. Pat. No. 7,270,796, which is incorporated herein by reference in its entirety for all purposes. FIG. 3 shows a non-limiting example of a system including a plurality of pre-processing steps/systems prior to introducing the acid-treated AD wastewater to an evaporation system (e.g., a CAST® system) and is described in more detail in Example 1.

In certain embodiments, AD wastewater may be pre-treated via use of dissolved air flotation (DAF) (not shown in FIG. 3). DAF is a water treatment process that comprises clarifying wastewaters (or other waters) by the removal of suspended matter such as oil or solids. The removal is achieved by dissolving air in the water or wastewater under pressure and then releasing the air at atmospheric pressure in a flotation tank or basin. The released air forms tiny bubbles which adhere to the suspended matter causing the suspended matter to float to the surface of the water where it may then be removed by a skimming device. Suitable DAF systems are commercially available.

In some embodiments, pre-treatment may comprise one or more filtration steps. Examples of suitable filtration processes and systems include depth filtration (e.g., multi-media filtration), microfiltration, nanofiltration, ultrafiltration. In some embodiments, the pre-treatment may comprise use of a screw press and/or a cartridge filter.

Multi-media filtration makes use of a depth filter that comprises two or more types of media and gravel under-bedding. Generally, the gravel support prevents smaller media from entering the distribution system and stops channeling of water. The coarse media layers in the top of the tank trap large particles, and smaller particles are trapped in the finer layers of media deeper in the filtering bed. Multi-media filtration can result in a highly efficient filtering, since removal takes place throughout the entire bed. Multi-media filters typically remove particles exceeding 5 to 15 microns in size as opposed to a conventional single media sand filter which removes primarily only particles with sizes of 30 micron or higher. Suitable multi-media filter systems are commercially available.

Ultrafiltration (UF) generally refers to a semi-permeable membrane filtration process that removes colloidal suspended solids and high molecular weight solutes. The retained solids and solutes are concentrated in the reject (retentate) stream, while water and low molecular weight solutes pass through the membrane into the permeate stream. The ultrafiltration system may be provided as an upstream unit operation to prevent fouling for a downstream reverse osmosis (RO) unit. Suitable ultrafiltration systems are commercially available.

Ultraviolet (UV) irradiation (not shown in FIG. 3) is a disinfection process which comprises using ultraviolet light at sufficiently short wavelength to kill bacteria and/or inhibit bacteriological growth. The use of an ultraviolet irradiation process as a pre-treatment in certain embodiments can serve to reduce bacteriological growth and contamination in downstream processes that could compromise their performance. Suitable ultraviolet irradiation are commercially available.

Ion exchange softening (not shown in FIG. 3) generally involves reducing the concentration of divalent metal cations (e.g., calcium, magnesium) in hard water and uses a cation resin that exchanges another, monovalent cation (e.g., sodium or potassium) for the various divalent ions. The ion exchange softening process can aid in preventing struvite formation and precipitation of sparingly soluble salts that could foul other system components and piping components downstream. Suitable ion exchange softening systems are commercially available. Non-limiting examples of such ion exchange softener systems are described in more detail in commonly owned U.S. Pat. No. 7,270,796, which is incorporated herein by reference in its entirety for all purposes.

In some embodiments, the AD wastewater stream may be processed through use of a reverse osmosis system. As will be known to those of ordinary skill in the art, reverse osmosis (“RO”) is a membrane separation process that is used to purify water by applying pressure to force water through a semi-permeable membrane, while leaving the majority of impurities on the feed side of the membrane. The RO membrane typically allows water to pass through, while retaining a large percentage of all solute molecules, which can be recovered in concentrated form as target chemicals on the retentate side of the RO membrane. The permeate, or solvent water which passes through the membrane, typically has significantly solute concentration than the feed water, and, in typical embodiments, is substantially pure water. The retentate stream, which remains upstream of the membrane, has higher concentrations of solute molecules than the permeate stream. Accordingly, during this process, any target chemical present in the feed is concentrated and recoverable from the system in the retentate stream, while purified water passes out of the system in the permeate stream.

In the case of ammonium as solute/target chemical, an RO system used as a pre-treatment step may be configured and operated so that the permeate stream flow rate comprises approximately 70-75% of the total feed flow rate and is sufficiently pure to be discharged in compliance with federal or state guidelines regarding ammonium limitations. The retentate flow rate from the RO unit may be approximately 25-30% of the total feed flow and can be further processed as described herein to recover ammonium salts as a useful product. Use of a RO system as a pre-treatment step may be advantageous to increase the ammonium concentration in the feed to the evaporation system of the invention and thus help reduce the quantity of water to be vaporized and associated equipment size and energy costs. These increases in efficiency may substantially reduce the associated capital and/or operating costs of an inventive system Suitable RO systems and membranes having various suitable rejection rates or molecular weight cutoffs are readily commercially available.

### Post-Processing Systems and Methods, and Collection Systems and Methods

Either or both of the collected vapor condensate and concentrated bottoms of the AD wastewater processed by the methods and systems of the present invention may be further treated with any number of post-treatment system components or method steps. For example, in some embodiments, following formation of the bottoms liquid in an evaporation system, which contains a second concentration of ammonia/ammonium, the bottoms liquid may be further processed or collected. In some cases, the bottoms liquid is processed to further concentrate the ammonia/ammonium, for example via additional evaporation steps (e.g., using a CAST® or an R-CAST®). Non-limiting examples of additional post-treatment steps that may be useful, in certain embodiments, for further treatment of the condensed vapor stream or bottoms liquid, depending on end use/disposal requirements, include dissolved air flotation, various types of filtration, ultraviolet irradiation, and ion exchange softening. In certain cases, the bottoms liquid comprising the concentrated ammonia/ammonium may be collected and used, e.g. as a fertilizer product, without substantial further processing.

Any of a variety of suitable liquid collection systems may be used with the methods and systems of the invention. In some embodiments, such a collection system may comprise one or more containers for collecting a final product solution in fluid connection with the final unit operation of the treatment or post-treatment systems described above. In some embodiments, the liquid collection system comprises a container comprising one or more inlets and/or outlets. In some embodiments, the container comprises an inlet for providing the treated wastewater, an inlet for providing a solution (e.g., an acid or basic solution to adjust the pH of the treated wastewater), and an outlet for removing the treated wastewater.

The following references are incorporated by reference herein in their entirety for all purposes:
U.S. Pat. No. 7,270,796, issued Sep. 18, 2007, entitled Ammonium/Ammonia Removal from a Stream and having the inventors Kemp et al.;
U.S. Patent Publication No. 2007/0297953 A1, published Dec. 27, 2007, entitled Ammonium/Ammonia Removal from a Stream and having the inventors Kemp et al.;
U.S. Pat. No. 4,770,748, issued Sep. 13, 1988, entitled “Vacuum Distillation System” and having the inventors Cellini et al.;
U.S. Pat. No. 4,880,504, issued Nov. 14, 1989, entitled Vacuum Distillation System with Spiralled Cold Coil and having the inventors Cellini et al.;
Environmental Protection Agency, Process Design Manual for Nitrogen Control, US Government Printing Office, Washington, D.C. (1975);
National Academy of Sciences, Nitrates: An Environmental Assessment, US Government Printing Office, Washington, D.C. (1978);
Benefield, Judkins and Weand, Process Chemistry for Water and Wastewater Treatment, Prentice Hall, Inc, Englewood Cliffs, N.J. (1982);
Minton, Handbook of Evaporation Technology, Noyes Publications, Park Ridge, N.J. (1986);
Dagger, Waltrip, Romm and Morales, Enhanced Secondary Treatment Incorporating Biological Nutrient Removal, Journal WPCF, vol. 60, no. 10 (1988); and
Tchnobanoglous and Burton, Wastewater Engineering, Treatment, Disposal and Reuse, third edition, Metcalf & Eddy, Inc., McGraw-Hill, New York, N.Y. (1991).

The following examples are included to demonstrate various features of the invention. Those of ordinary skill in the art, in light of the present disclosure, will appreciate that many changes can be made in the specific embodiments which are disclosed while still obtaining a like or similar result without departing from the scope of the invention as defined by the appended claims. Accordingly, the following examples are intended only to illustrate certain features of the present invention.

### Example 1

This example provides a prophetic description involving forming an acid-treated AD wastewater stream and subjecting the acid-treated AD wastewater stream to a plurality of pre-processing step. See FIG. 3.

Initially, chicken manure may be digested in anaerobic digester (AD) 350. In the AD, the nitrogen content can be increased as much as possible and the final product may retain a portion of the organic materials present in the manure. As will be known to those of ordinary skill in the art, retention of substantial organic products along with the nitrogen content result in generally better fertilizer performance and greater crop yield than use off plain nitrogen enriched fertilizer.

The wastewater from the AD may then be acid-treated. For example, the AD wastewater can be provided to mixing tank 352 where acid 354 (e.g., citric acid) is added and the acid-treated AD wastewater is formed. The acid reacts with the dissolved ammonia gas in the digestate to produce ammonium salt (e.g., ammonium citrate). The pH of the digestate, for example, can be adjusted by addition of sufficient acid to be between about 5 and about 7. A pH of 6 was targeted, in part, because of the economics of using citric acid and reducing ammonia carryover in the CAST° system used for further processing (see Example 2); however, other pHs may be targeted. The digestate can then be mixed to release carbon dioxide. In some cases, this mixing can aide in reducing foaming in the CAST®.

After the foaming stopped, the digestate can be processed through a filtration process comprising a screw press (356), micro and cartridge filters (358 and 360), and ultrafiltration (362). The screw press and filters remove the larger solids from the digestate. The digestate can then be processed through ultrafiltration (UF) to remove some of the smaller size solids. Two streams are produced by the ultra-filter, UF brine/reject 364 and UF permeate 366. UF reject/brine 364 can be removed from the process as waste but may find use as a soil conditioner.

UF permeate 366 can then be processed and concentrated with reverse osmosis (RO, 370). Additional acid may be added during the process (e.g., 367, prior to the UF and/or prior to the RO). The RO can be run as a concentrator. RO brine 372 can be removed from the filter and recycled back to the AD feed while the permeate is disposed. After a number of cycles of recycling the brine back to the feed, the pressure may be too high to continue running the RO system and the RO brine/reject stream 372 can be further processed via a CAST° system as described in Example 2.

### Example 2

This example involved concentrating ammonia/ammonium in the acid-treated AD wastewater stream pre-treated as described in Example 1 above.

Acid-treated AD wastewater stream 372 (See FIG. 3) pre-processed as described in Example 1 was provided to CAST° system 374. The CAST° system was operated as a single stage distillation stage under vacuum, which lowered the boiling point and allowed the system to be built with more economical materials. Table 3 provides a summary of the parameters for the experiments conducted according to this Example and the corresponding results. FIG. 2 as described herein for more details regarding the operation of a CAST® system and is described in more detail below. In this example, the CAST® comprises a 12″ diameter vessel. The capacity of the system was around 500 gpd. The temperature of the system was between about 110 F and about 130 F. The vacuum pressure was between about 26 and 28 in Hg. A benefit to using the CAST° system with AD wastewater in this Example is that less ammonia was lost in the vapor stream, and the unit can operate at lower boiling temperatures. The CAST° system was used to evaporate water from the acid-treated AD wastewater stream. Acid-treated AD wastewater stream 372 was transferred from the evaporator vessel to a heat exchanger (see 220 in FIG. 2), where the fluid was heated to the boiling point. After the heat exchanger, the digestate was pumped back into a spray nozzle (see 208 in FIG. 2) which emptied back into the CAST° vessel (see 204 in FIG. 3). The spray nozzle atomized the digestate creating more surface area for the water/distillate to evaporate. The CAST° system vaporized a portion of the acid-treated AD wastewater stream, thereby forming vapor portion 376 and bottoms 378 (see also 214 in FIG. 2). Bottoms 378 (see also 214 in FIG. 2) comprised ammonia/ammonium at a greater concentration as compared to the acid-treated AD wastewater provided to the CAST° system.

TABLE 3

| | | | CAST ® | | | | | | Feed | Recovered Concentrate | | |
|---|---|---|---|---|---|---|---|---|---|---|---|---|
| | Initial Acid-treated | | pH | Lbs | | De-gas | pH | NH₄ | Total | Total Liters | | |
| Experiment | AD Wastewater stream | | Adjusted | Acid | De-gas | Time | after | after | Liters | Concentrate | | NH₄ of |
| # | pH | NH₄ | (Y/N) | Added | (Y/N) | (minutes) | De-gas | De-gas | Fed | Recovered | pH | Concentrate |
| 1 | 6.3 | 1.88% | N | 0 | N | N/A | 6.3 | 1.75% | 131.35 | 20.26 | 6.5 | 8.18% |
| 2 | 6.5 | 1.72% | N | 0 | Y | 8.97 | 6.6 | 1.78% | 103.77 | 22.22 | 6.5 | 6.01% |
| 3 | 6.3 | 1.58% | N | 0 | Y | 5.92 | 6.3 | 1.47% | 109.74 | 22.30 | 6.5 | 6.06% |
| 4 | 6.2 | 1.64% | N | 0 | N | N/A | 6.2 | 1.62% | 81.22 | 20.72 | 6.2 | 4.59% |
| 5 | 6.0 | 1.89% | N | 0 | Y | 6.03 | 6.0 | 1.91% | 99.05 | 21.26 | 6.2 | 6.50% |
| 6 | | | | | | | | | | 22.00 | 6.6 | 8.83% |
| 7 | 6.3 | 1.58% | N | 0 | N | N/A | 6.2 | 1.80% | 128.75 | 22.31 | 6.5 | 6.92% |
| 8 | 6.1 | 1.50% | N | 0 | N | N/A | 6.1 | 1.60% | 143.70 | 22.40 | 6.5 | 7.34% |
| 9 | 6.1 | 1.49% | N | 0 | N | N/A | 6.1 | 1.54% | 152.5 | 22.4 | 6.6 | 7.64% |
| 10 | 6.2 | 1.62% | N | 0 | Y | 1.08 | 6.2 | 1.56% | 192.82 | 21.30 | 6.4 | 9.41% |
| 11 | 6.1 | 1.78% | N | 0 | Y | 7.58 | 6.1 | 2.05% | 186.46 | 22.19 | 6.4 | 9.74% |

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

The indefinite articles “a” and “an,” as used herein in the specification and in the claims, unless clearly indicated to the contrary, should be understood to mean “at least one.”

As used herein in the specification and in the claims, “or” should be understood to have the same meaning as “and/or.” For example, when separating items in a list, “or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” In the claims, as well as in the specification above, all transitional phrases such as “comprising,” “including,” “carrying,” “having,” “containing,” “involving,” “holding,” and the like are to be understood to be open-ended, i.e., to mean including but not limited to.

1. A method for producing a composition comprising ammonia and/or ammonium from a bioreactor wastewater stream, comprising:
providing an acid-treated wastewater steam from a bioreactor, wherein the acid-treated bioreactor wastewater stream comprises ammonia and/or ammonium at a first concentration, to an evaporation system wherein a portion of the acid-treated bioreactor wastewater stream is vaporized and a bottoms liquid is formed comprising a de-watered, more concentrated solution of the ammonia and/or ammonium, the bottoms liquid having a second concentration of ammonia and/or ammonium which is greater than the first concentration; and
collecting the bottoms liquid.

2. The method of claim 1, wherein bioreactor wastewater stream is an anaerobic digester wastewater stream.

3. The method of claim 2, further comprising following providing the acid-treated anaerobic digester wastewater to the evaporation system, degasifying the acid-treated anaerobic digester wastewater stream prior to and/or intermittently during the vaporization.

4. The method of claim 3, wherein the degasifying removes a gas formed by the conversion of ammonia to ammonium.

5. The method of claim 4, wherein the conversion comprises reaction of ammonia with an acid to produce ammonium, wherein the acid is added following providing the acid-treated anaerobic digester wastewater to the evaporation system.

6. The method of claim 4, wherein the gas is carbon dioxide.

7. The method of claim 3, wherein the degasifying comprises agitating, heating, adding a defoamer, and/or applying a vacuum to the acid-treated anaerobic digester wastewater stream.

8. The method of claim 2, wherein the acid-treated anaerobic digester wastewater stream comprises one or more organic compounds.

9. The method of claim 8, wherein the one or more organic compounds comprise one or more byproducts of an anaerobic digestion process.

10. The method of claim 8, wherein at least one of the one or more organic compounds is a surfactant.

11. The method of claim 4, wherein the degasifying is carried out under conditions to prevent foaming of the acid-treated anaerobic digester wastewater stream.

12. The method of claim 5, wherein the acid-treated anaerobic digester wastewater stream is acid-treated by addition of an organic acid.

13. The method of claim 5, wherein the acid is comprises inorganic acid.

14. The method of claim 13, wherein the acid comprises sulfuric acid, phosphoric acid, citric acid, nitric acid, hydrochloric acid, acetic acid, or mixtures thereof.

15. The method of claim 14, wherein the acid is citric acid.

16. The method of claim 1, wherein the evaporation system comprises a container, a spray nozzle, and a baffle positioned in the container above the spray nozzle.

17. The method of claim 1, wherein the bottoms liquid is collected using a collection system.

18. The method of claim 3, wherein the pH of the acid-treated anaerobic digester wastewater stream prior to vaporization is between about 1 and about 8, or between about 2 and about 8, or between about 3 and about 8, or 4 and about 8, or between about 5 and about 7, or between about 6 and about 7, or about 1, or about 2, or about 3, or about 4, or about 4.5, or about 5, or about 5.5, or about 6, or about 6.5, or about 7, or about 7.5, or about 8.

19. The method of claim 14, wherein when the acid is sulfuric acid, nitric acid, phosphoric acid, or hydrochloric acid, the pH of the acid-treated anaerobic digester wastewater stream is not less than 2, or between about 2 and 8, or between about 3 and 8, or between about 4 and 8, or between about 5 and 8, or between about 6 and 8, or about 2, or about 3, or about 4, or about 4.5, or about 5, or about 5.5, or about 6, or about 6.5, or about 7, or about 7.5, or about 8.

20. The method of claim 14, wherein when the acid is acetic acid or phosphoric acid, the pH of the acid-treated anaerobic digester wastewater stream is not less than 3, or between about 3 and 8, or between about 4 and 8, or between about 5 and 8, or between about 6 and 8, or about 3, or about 4, or about 4.5, or about 5, or about 5.5, or about 6, or about 6.5, or about 7, or about 7.5, or about 8.

21. The method of claim 14, wherein when the acid is acetic acid or citric acid, the pH of the acid-treated anaerobic digester wastewater stream is not less than 4, or between about 4 and 8, or between about 5 and 8, or between about 6 and 8, or about 4, or about 4.5, or about 5, or about 5.5, or about 6, or about 6.5, or about 7, or about 7.5, or about 8.

22. The method of claim 3, wherein the pressure during the vaporizing step and/or during degasifying is between about 10 and about 29 inches Hg vacuum, or between about 15 and about 29 inches Hg vacuum, or between 20 and about 29 inches Hg vacuum, or between about 25 and about 29 inches Hg vacuum, or between about 26 and about 29 inches Hg vacuum, or between about 27 and about 29 inches Hg vacuum, or between about 28 and about 29 inches Hg vacuum, or about 25 inches Hg vacuum, or about 26 inches Hg vacuum, or about 27 inches Hg vacuum, or about 28 inches Hg vacuum, or about 29 inches Hg vacuum.

23. The method of claim 1, wherein the second concentration is 1.5 times, or 2 times, or 3 times, or 4 times, or 5 times, or 6 times, or 7 times, or 8 times, or 9 times, or 10 times, or 15 times, or 20 times, or 30 times, or 40 times, 50 times, or 60 times, or 70 times, or 80 times, or 90 times, or 100 times greater than the first concentration.

24. The method of claim 1, wherein the second concentration of ammonia and/or ammonium is greater than about 5 wt %, or greater than about 6 wt %, or greater than about 7 wt %, or greater than about 8 wt %, or greater than about 9 wt %, or greater than about 10 wt %, or greater than about 15 wt %, or between about 5 wt %, and about 15 wt %, or between about 5 wt %, and about 10 wt %,

25. The method of claim 14, wherein when the acid is sulfuric acid, the second concentration of ammonia and/or ammonium is not more than about 43%, or between about 5 wt % and about 43 wt %, or between about 5 wt % and about 40 wt %, or between about 5 wt % and about 30 wt %, or between about 5 wt % and about 20 wt %, or between about 5 wt %, and about 15 wt %, or between about 5 wt % and about 10 wt %.

26. The method of claim 14, wherein when the acid is nitric acid, the second concentration of ammonia and/or ammonium is not more than about 66%, or between about 5 wt % and about 66 wt %, or between about 5 wt % and about 60 wt %, or between about 5 wt % and about 50 wt %, or between about 5 wt % and about 40 wt %, or between about 5 wt % and about 30 wt %, or between about 5 wt % and about 20 wt %, or between about 5 wt %, and about 15 wt %, or between about 5 wt % and about 10 wt %.

27. The method of claim 14, wherein when the acid is acetic acid, the second concentration of ammonia and/or ammonium is not more than about 59%, or between about 5 wt % and about 59 wt %, or between about 5 wt % and about 50 wt %, or between about 5 wt % and about 40 wt %, or between about 5 wt % and about 30 wt %, or between about 5 wt % and about 20 wt %, or between about 5 wt %, and about 15 wt %, or between about 5 wt % and about 10 wt %.

28. The method of claim 14, wherein when the acid is phosphoric acid, the second concentration of ammonia and/or ammonium is not more than about 17%, or between about 5 wt % and about 17 wt %, or between about 5 wt %, and about 15 wt %, or between about 5 wt % and about 10 wt %.

29. The method of claim 14, wherein when the acid is hydrochloric acid, the second concentration of ammonia and/or ammonium is not more than about 27%, or between about 5 wt % and about 27 wt %, or between about 5 wt % and about 20 wt %, or between about 5 wt %, and about 15 wt %, or between about 5 wt % and about 10 wt %.

30. The method of claim 15, wherein when the acid is citric acid, the second concentration of ammonia and/or ammonium is not more than about 40%, or between about 5 wt % and about 22 wt %, or between about 5 wt % and about 40 wt %, or between about 5 wt % and about 30 wt %, or between about 5 wt % and about 20 wt %, or between about 5 wt %, and about 15 wt %, or between about 5 wt % and about 10 wt %.

31. The method of claim 1, wherein substantially all or all of the ammonia in the bottoms liquid is in the form of ammonium.

32. The method of claim 1, wherein the evaporation system is a flash evaporation system.
